(19) United States
(12) Patent Application Publication
(10) Pub. No.: US 2012/0282569 A1
(43) Pub. Date: Nov. 8, 2012

(54) FILLING STATION FOR SELF-CONTAINED DENTAL WATER SUPPLY SYSTEMS AND METHOD OF USE

(76) Inventor: Jimmy D. Disel, Sparks, NV (US)

(21) Appl. No.: 13/466,110

(22) Filed: May 7, 2012

Related U.S. Application Data
(60) Provisional application No. 61/482,921, filed on May 5, 2011.
(60) Provisional application No. 61/482,990, filed on May 5, 2011.

(51) Int. Cl. A61C 17/02; B67D 7/72; B67D 7/08

(52) U.S. Cl. 433/80; 222/639; 222/399; 222/544

(57) ABSTRACT

One possible embodiment of the invention could a filling station for fluid containers used in self-contained dental water supply systems comprising at least one pressurized fluid supply; at least one low pressure gas supply; the first valve circuit continuously connecting to the at least one pressurized fluid supply; the second valve circuit continuously connecting to the at least one low pressurized gas supply; the manifold that continuously connects to first and second valve circuits; a cap that attaches to a fluid container used in self-contained dental water supply system, the cap reversibly and continuously connects an interior of the fluid container to the manifold; an electronic control unit utilizing one or more timer circuits, wherein each timer circuit operates its respective valve circuit for a predetermined amount of time to deliver a predetermined amount of gas or fluid at a predetermined pressure into the interior of the fluid container.

### CROSS-REFERENCES TO RELATED APPLICATIONS

This application claims the benefit under 35 U.S.C. § 119(e) of U.S. Provisional Patent Application No. 61482921, and U.S. Provisional Patent Application No. 61482990, both of which were filed on May 05, 2011, contents of which are relied upon and incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

1. Field of the Invention

The present invention relates to filling stations that file fluid containers used in a self-contained water supply system of dental work stations. More particularity to those filling stations that may automate some of the functions as provided by such filling stations.

2. Background

One of the growing concerns in the field of dentistry is the continued confirmation of microbial contamination of dental work station waterlines used to deliver water for dental operations. Generally, these waterlines conduct tap water from a continuous water supply (e.g., tap water provided by a municipal water supply) or the like to a dental operation site proximate a dental work station. Research conducted in these matters has generally confirmed the repeated presence of bacteriological pathogens such as Sphyngomonas paucimobilis, Acinetobacter calcoaceticus, Methylobacterium mesophilicum, and Pseudomonas aeruginosa in dental work station waterlines. Forensic pathology has further confirmed cases of transmission of water-based pathogens including that of Legionella pneumophila, the causative agent of legionaries disease, to dental patients and dental healthcare professionals (dental operators) thorough these contaminated dental waterlines. One current theory regarding this kind of contamination is that the small bore of water supply lines or conduits allows a biofilm to form upon the interior surface of the water lines despite the continuous water source (e.g., tap water) being chlorinated. As such, these dental station waterlines (continuous water source) could be considered a potential aquatic ecosystem in which opportunistic pathogens can successfully colonize synthetic waterline surfaces to the point of providing a potentially dangerous concentration level of the pathogens in supplied water directly supplied to the dental patient or indirectly to dental healthcare professional (e.g., supply water being aerosolized during dental operations.)

Presently, there is a movement within the dental field to move away from a continuous water supply source to a generally self-contained dental water supply system that is no longer directly connected to an outside, continuous tap water source. The self-contained dental water supply system may be integrated into a dental work station and may use removable fluid containers to hold distilled water for supplying water in dental operations. These fluid containers are regularly changed out and replenished with water depending on the amount of dental operations being scheduled for that dental work station. These fluid containers may be regularly changed out and replenished with fluid containers containing disinfectant to clean the self-contained water supply systems depending on the amount of dental operations being scheduled for that dental work station.

One of the possible difficulties encountered with self-contained dental water supply systems could be system contamination by dental operators in changing out the fluid containers. Many current self-contained dental water supply systems may require the dental operator to manually disconnect (e.g., unscrew) the fluid container from the dental self-contained water supply system and withdraw the fluid container from a fluid pickup tube used by the system to remove fluid from the fluid container. Due to the general awkwardness of this removal process, the dental operator could come into contact with the pickup tube and otherwise cause its contamination, potentially leading to further contamination of the remaining water supply system.

Another problem could be that such filling stations for self-contained dental water systems may rely upon the dental operator's continual observation of the water system with resulting dental operator's intervention for the system to operate properly. The water system may require the dental operator to constantly monitor the filling station operations to visually determine the amount of fluid in the fluid container instead of conducting dental operations.

Another problem may be that the existing filling stations may require that the dental operatives have to continually regulate the operations of these filling stations (e.g., adjusting the air pressure running the filling station, directing and monitor the filing of fluids, monitor which fluids are used; and the like) to properly prepare the field containers for future use. Sometimes, the dental operative's adjustments may be improper and resulting in fluid leakage from the fluid container (e.g., spraying water over the dental work space) or worse.

What is needed therefore may be a filling station for self-contained dental water supply that uses a cap with fluid pickup tube that attaches to the open end of the fluid container so that the fluid pickup tube stays in the fluid container an away from outside contamination. This filler station in using a cap/fluid container combination may also provide for automatic control over the amount of fluid to delivered into in the fluid container, automatic control over delivery of fluid (water or disinfectant) to be delivered to fluid containers; automatically control over the delivery and length of delivery of pressurized gas to vacate fluid from the fluid containers, and automatic control for sequentially order the performance of it operations.

### SUMMARY OF ONE EMBODIMENT OF THE INVENTION

### Advantages of One or More Embodiments of the Present Invention

The various embodiments of the present invention may, but do not necessarily, achieve one or more of the following advantages:
to provide a filling station for self-contained dental water systems that could automatically attach to a cap/fluid container combination;
the ability to automate a self-contained dental water system's filling station's selection of types of fluids to be delivered to a cap/fluid container combination;
provide a filling station for self-contained dental water system that could automatically controls the amount of fluid delivered to a cap/fluid container combination;
the ability to automate a self-contained dental water system's filling station's creation and delivery, and duration of delivery of gas delivered to a cap/fluid container combination to vacate any fluids from the combination;
provide a filling station for self-contained dental water system that could automatically control the sequence of the steps of its operation; and
the ability to automate a self-contained dental water system's filling station to use timing and pressure of its gas and fluid supplies to control the amounts of gas or fluids delivered to cap/fluid container combination.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a filling station for fluid containers used in self-contained dental water supply systems comprising at least one pressurized fluid system; at least one low pressure gas system; the first valve circuit continuously connecting to the at least one pressurized fluid system; the second valve circuit continuously connecting to the at least one low pressurized gas system; the manifold continuously connects to first and second valve circuits; a cap that attaches to a fluid container used in self-contained dental water supply system, the cap reversibly and continuously connects an interior of the fluid container to the manifold; an electronic control unit that utilizes one or more timer circuits, each timer circuit connects to its respective valve circuit to control that valve circuit's operations; wherein each timer circuit operates its respective valve circuit for a predetermined amount of time to deliver a predetermined amount of gas or fluid at predetermined pressure into the interior of the fluid container.

Another possible embodiment of the invention could be a filler station for fluid containers used in self-contained dental water supply systems comprising a manifold that continuously connects a fluid container to at least two or more valve circuits; a plurality of valve circuits, each valve circuit comprising of a dual state valve, each dual state valve continuously connecting to the manifold and to a common drain/vent, each dual state valve is controlled by an solenoid-operated air valve, the solenoid-operated air valve continuously connecting the dual state valve to a high pressure gas system to actuate the dual state valve from one state of operation to another state of operation; at least one pressurized fluid system pressurized to a predetermined level, the least one pressurized fluid system continuously connects to a first valve circuit of the plurality of valve circuits; at least one low pressure gas system pressurized to a predetermined level, the at least one low pressure gas system continuously connects to a second valve circuit of the plurality of valve circuits; an electronic controller unit that has more than one timer circuit, each timer circuit being connected to its respective solenoid of the solenoid-controlled air valve, each timer circuit running a respective valve circuit for a predetermined amount of time to deliver a predetermined amount of pressurized fluid or low pressure gas to the manifold.

Another possible embodiment of the invention could be The process for operation of a filing station for fluid containers used in a self-contained dental water supply system comprising of the following steps, but not necessarily in the order presented; providing a filing station with a manifold that continuously connects the interior a fluid container to at least two or more valve circuits; one valve circuit continuously connects the manifold to a pressurized fluid system or a common drain/vent, the pressurized fluid system being pressurized at a predetermined pressure, a second valve circuit continuously connects the manifold to a low pressurize gas system or the common drain/vent, the low pressure gas system being pressurized at the predetermined pressure, the valve circuits being connected to and operated by respective timer circuits of a electronic controller unit; activating either the first or second valve circuits through its respective timer unit for a predetermined amount time to deliver either a gas or a fluid in a predetermined amount to the interior of the fluid container; and de-activating the remaining valve circuit through its respective timer unit to continuously connect the interior of the fluid container to a common drain/vent, the activating and deactivating occurring at the same time.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of one embodiment of the present invention.

FIG. 2 is substantially a cutaway elevation view of one embodiment of the cap system of the present invention.

FIG. 3 is substantially a piping schematic view of one embodiment of the present invention.

FIG. 4 is substantially a piping schematic view of another embodiment of the present invention.

FIG. 5 is substantially an electronic schematic showing one embodiment of electronic control unit of the present invention.

FIG. 6 is substantially a flow chart showing one embodiment of process or method for operating the filling station of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

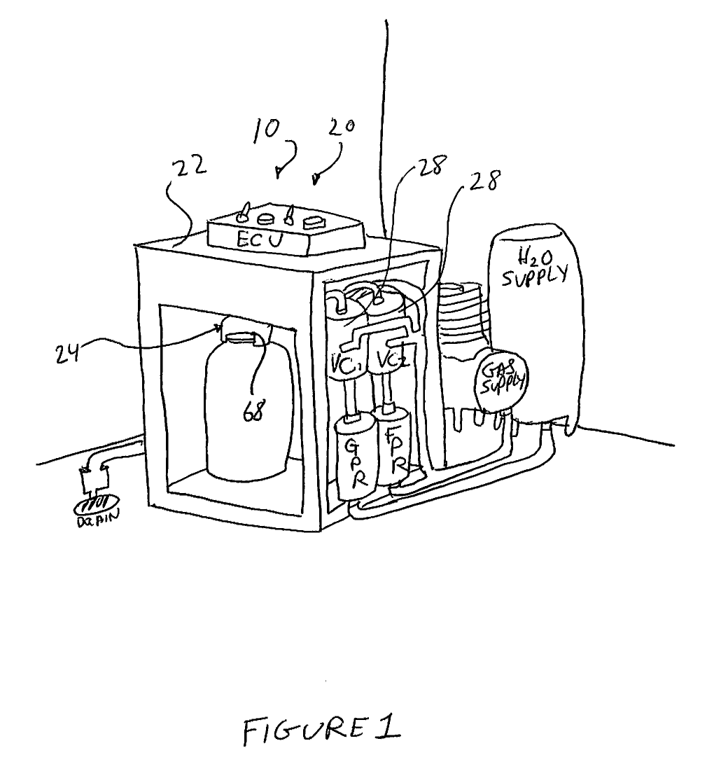

The present invention 10 could comprise of a filling station 20 for a self-contained dental water system and a method for the filling station's method of use 200. As generally shown in FIG. 1, the filling station 20 could comprise of a structure framework 22 that generally supports its other components, namely a cap system 24 connected by to a high pressure gas system 26; one or more valve circuits 28, the one or more valve circuits 28 generally controlled by an electronic control unit 30; the valve circuits 28 further being also continuously connect the cap system 24 to at least one low pressure gas system 32 and at least one pressurized fluid system 34

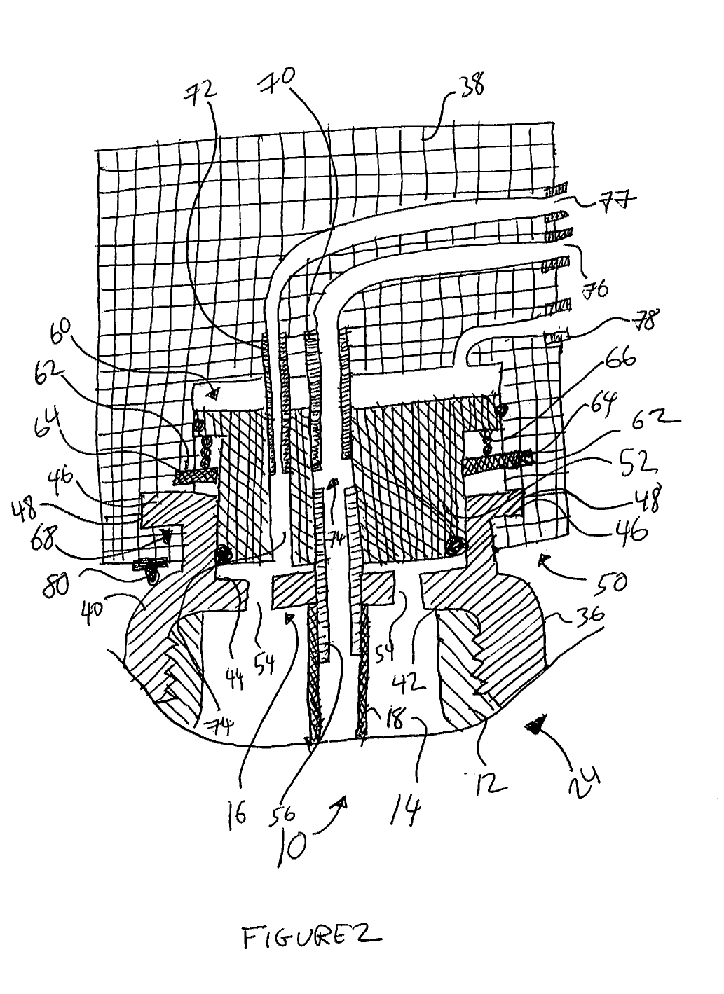

As generally shown in FIG. 2, the cap system 24 could comprise of a cap 36 and a cap manifold 38 wherein the cap 36 reversibly attaches to and generally seal the open end 16 of a fluid container 12 to place a fluid pickup tube 16 within the fluid container's interior 22. The cap 36 could be further capable of reversibly quick-attaching to the cap manifold 38 to reversibly connect the fluid container's interior 14 to the filling station 12.

The cap 20 could comprise of a cylindrically-shaped cap body 40 having a container end 42 and a holder end 44. The container end 42 could be recessed with a connection capability (e.g., being threaded along its inside wall to reversibly engage the threads of the open end 16 of the fluid container 12) to reversibly attach to and generally seal a threaded open end 16 of the fluid container 12. The outside wall of the cap 36 by the holder end 44 could support a collar 46 that could be received within a second ring groove 48 of a manifold 38 to reversibly hold the cap 36 within a bottom manifold end 50 of the manifold 38. The holder end 44 could also be similarly recessed to reversibly receive a smaller diameter portion of the sealing plunger 52 of the manifold 38, the sealing plunger 52 generally continuously connecting the top of cap 36 and fluid container's interior 14 to the self-contained dental water system 16. The cap 42 could have one or more low pressure apertures 54 passing through the cap body 40 to directly connect the recess of the container end 42 to that of the holder end 44. A double-opened, hollow fluid tube 56 could passes through the radial axial center of the cap 36 and is barbed on container end 42 to receive and hold a fluid pickup tube 18 that goes into the fluid container's hollow interior 14. Although the fluid containers 12 could be of a multitude of sizes and shapes, their open end 16 is generally sized and configured to allow proper attachment of the fluid container 12 to the cap 36.

The manifold 38 could be comprised of a generally cylindrical-shaped manifold body 58 having a bottom manifold end 50 that is recessed into an open-ended cavity 60. The open ended cavity 60 that may movably receive a sealing plunger 52. The walls of the recess of the bottom manifold end 50 could have a first ring groove 62 and a second ring groove 48, the two ring grooves 62, 48 being spaced apart in parallel orientation. The first ring groove 62 could receive a C-spring clip 64 to movably retain the sealing plunger 52 and its biasing spring 66 within the bottom manifold end 50. The biasing spring 66 generally orienting the sealing plunger 52 into the open-end cavity 60 towards its ceiling. The second ring groove 48 could intercept a cutout 68 that is on the rim or ridge of the bottom manifold end 50, which allows the cap 36 to load sideways into the open-ended cavity 60 to sandwich the sealing plunger 52 between side ways inserted cap 36 and ceiling of the open-ended cavity 60. The first ring groove 62 reversibly receives and seats a portion of the cap's collar 46 to hold the cap/fluid container combination to the manifold 38.

The bottom manifold end 50 could further support a hollow, double open-ended manifold fluid tube 70 and a hollow, open-ended gas tube 72 descending downward from the ceiling of the open-ended cavity 60 to allow controlled connection of self-contained dental water supply system's gas and fluid supplies to cap/fluid container combination. The two tubes 70, 72 generally pass into a set of tube channels 74 in the sealing plunger 52, allowing the sealing plunger 52 to move and extend a connection between the manifold gas tube 72 and one or more low pressure gas aperture 54 as well as extend a connection between the manifold fluid tube 86 and the cap fluid tube 56.

A fluid channel passing through the manifold 38 could continuously connect the manifold fluid tube 70 to a fluid inlet/outlet 76 located on the outside of the manifold body 58.

A low pressure gas channel passing through the manifold body 58 could continuously connect the manifold gas tube 72 to a low pressure gas inlet/outlet 77.

A high pressure gas channel in the manifold 72 may connect a high pressure gas inlet/outlet 78 on the side of the manifold body 58. The high pressure gas directed the high pressure gas inlet/outlet 78 could flow into the open-ended cavity 60 to push the sealing plunger 52 against its bias spring 66 to seat the sealing plunger 52 against the top of the cap 36 to reversibly secure the cap 35 into the manifold 38. When the filling station 20 no longer supplies the manifold 38 with high pressure gas (e.g., vents the high pressure inlet/outlet 78) the biasing spring 66 pushes the sealing plunger 52 away from the cap 36 and back into the recess of the open-ended cavity 60.

The sealing plunger 52 could be shaped like a disk stacked upon a larger diameter disk with edges of each disk supporting a respective 0-ring making a movable, sealing contact with the sidewall of the open-ended cavity 60 during the sealing plunger's movement relative to the open-ended cavity 60. The center of the sealing plunger 52 could feature tube channels 74 as previously described. The smaller diameter portion of plunger 52 could be positioned within the center of the biasing spring 66 (e.g., an expanding coil spring) that generally biases the sealing plunger 52 towards the ceiling of the open-ended cavity 77, the C-clip spring 64 generally holding the biasing spring 66 and the sealing plunger 52 within the manifold 38.

As the sealing plunger 52 is moved by high pressure gas into contact with the cap 36, the smaller diameter portion of the sealing plunger 52 seats within and generally seals the cap 42. One of the tube channels 74 could descend upon the cap fluid tube 56 to substantially create a continuous connection between the manifold fluid tube 70 and the cap's fluid tube 56. The seating of the plunger 52 substantially creates a generally sealed air space between the bottom of the sealing plunger 52 and the end cap recess so that the tube channel 74 attached to the manifold gas tube 72 can then direct the low pressure gas toward the one or more low pressure gas apertures 54 of the cap 36 and into the fluid container's interior 14.

In at least one embodiment, the manifold 38 could further comprise of an electrical pressure switch 80 so mounted on the manifold 38 that it is only actuated by the presence of the cap 36 or fluid container 12 in the correct operational proximity to the manifold 38. The electrical pressure switch 80 could be connected to the electronic control unit 30 for the filling station 20 to allow such operations only when the electrical pressure switch 80 is actuated. In this manner, the filling station 20 would not emit fluid when the fluid container 12 is not properly connected to the filling station 20 to prevent accidental spillage of the fluid.

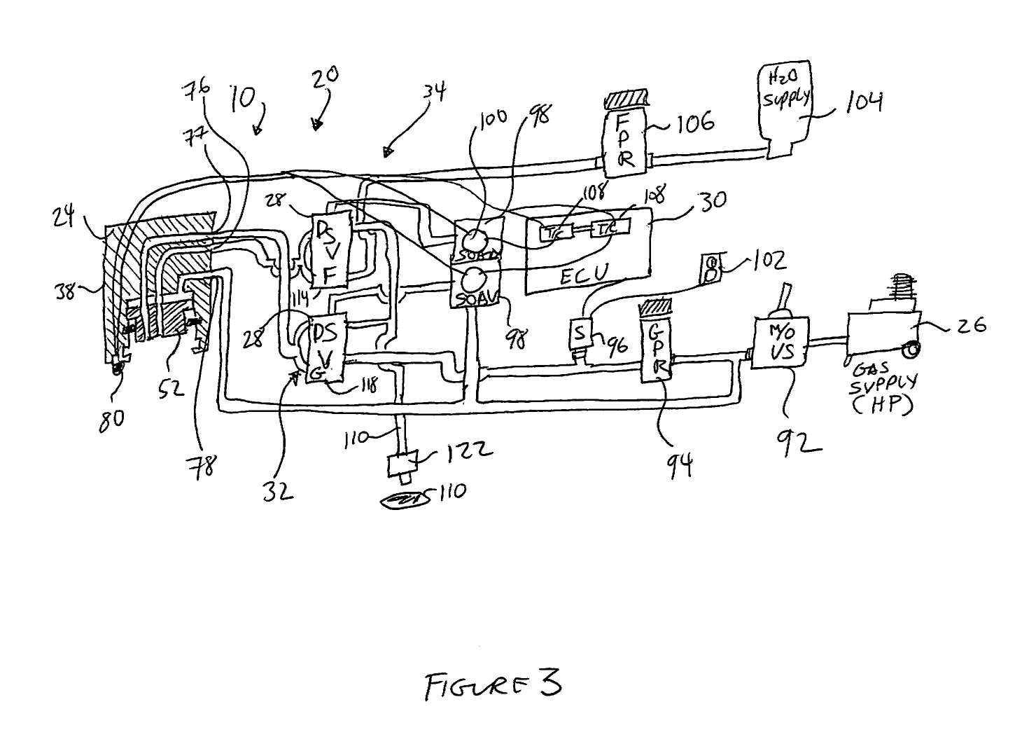

As substantially shown in FIG. 3, the filling station 12 by pressurizing fluid(s)/low pressure gases at a predetermined pressure(s) can then constantly deliver a certain amount fluid/gas per certain time unit to the manifold 36. The filling station by using electronic timer circuits to control length of the actuation duration of a respective valve circuit can cause automatic and constant delivery of fluid/gas at desired predetermined amounts to a respective manifold 36 thus alleviating need for dental operator intervention during fluid/gas delivery and other filling station operations.

The gas supply for the filling station 12 could be provided by large pressurized gas reservoir or tank, a gas air compressor, a gas compressor/tank combination, or the like [not shown]). The air compressor could be a commercially available air compressor/air tank combination that can be operator set to be automatically activated when the amount of gas (e.g., gas pressure) in the system/tank drops below a predetermined amount (e.g., pressure.) In one possible embodiment of the invention 10, the pressurized gas (e.g., air) from gas generator could be set at 80 PSI. The pressurized gas system thus generated could be denoted as the high pressure gas system 26. The high pressure gas could then be directed through a manually-operated air valve 92 (as selected by one having skill in the art.)

In one embodiment, when the manually-operated air valve 92 is opened by the dental operator (or other suitable personnel), it connects the high pressure gas system 26 to the rest of the filling station 12. When the manually-operated air valve 26 is turned off, it blocks the passage of the high pressure gas to the rest of the filling station 12 and vents the valve's outgoing high pressure gas line to the outside environment. In this manner, the manually-operated air valve 26 can vent both the filling station's low pressure gas system 32 (e.g., the gas pressure regulator 94, the gas pressure electrical switch 96; the solenoid operated-gas valves 98 [e.g., turning off power to the filing station's electronic control unit 30] and filling station's high pressure gas portion (e.g., the manifold's high pressure inlet/outlet 78 [e.g., allowing the sealing plunger 52 to recede within the open-ended cavity 60 and to permit removal from the manifold 38 of the cap/fluid container combination]) to the outside environment. The manually-operated air valve 92 can be continuously connected to the gas pressure regulator 96 and the manifold's high pressure inlet/outlet 78.

The gas pressure regulator 94 (as selected by one having ordinary skill in the art) could be set to reduce the incoming high pressure gas to be issued having lower pressure (e.g. 50 PSI) to create a lower pressure gas. This lower pressure gas could be used in this portion of the filling station to prevent over-pressurization of the fluid container 12, leading to its breakage/rupture or that of other parts of the cap system 24.

The lower pressure gas as emitted by the gas pressure regulator 94 is then directed to a gas pressure electrical switch 96 that is electrically connected to the filling station's electronic control unit 30 and to the power supply unit. As the lower pressure gas contacts and presses against the gas pressure electrical switch 96, this actuates the gas pressure electrical switch 96 to allow its electrical portion to complete an electrical circuit that connects the electrical power to the electronic control unit 30 to energize the electronic control unit 30. The low pressure gas may then be the directed to valve circuit (s) 28 to generally supply the solenoid-controlled gas valves 98 (allowing them to control the dual state valves of the valve circuit[s].)

The fluid pressure system 34 could have a fluid source 104 (e.g., a sterile water generator) at a pressure greater that 50 PSI. As denoted earlier, it's necessary to have predetermined fluid pressure to allow for timed delivery for desired predetermined amounts of fluid and to keep the fluid operating at a pressure that is safe for use in the cap system 24. The pressurized fluid (50 PSI) as emitted by fluid pressure regulator 106 could then be delivered to one or more dual state valves 84 of one or more valve circuits 26.

The valve circuit 26 could comprise of one dual state valve 84 that is air-controlled by a solenoid-operated gas valve 98 (as selected by one skilled in the art), which in turn could be controlled by a timer circuit 108 (e.g., electronic control unit 30.) The utilization of an air-powered dual state valve 84 that is in indirectly controlled (e.g., by high pressure gas delivered by air valve portion of the solenoid-controlled gas valve 98) by remote solenoid 100 could allow inexpensive and quick replace of a dual state valve 84, especially when fluid controlled by the filling station 20 can be detrimental to the mechanical portion of the dual state valve 84. It is well within the scope of the invention 10, in an alternative embodiment, to utilize a dual state valve 84 that is fully and directly integrated with a solenoid 100 instead. However, the repair or replacement of a solenoid integrated/controlled dual state valve 84 could be a significantly more expensive proposition to replace/repair that that of a dual state valve 84 remotely operated through pressurized gas (high) delivered by a remotely located solenoid-operated gas valve 98. It would also be possible to time and operate the dual state valves through a purely pneumatic means and avoid the use to electronic controls.

The dual state valve 84 could be one selected by one skilled in the art of valves. The dual state valve 84 would be air pressure operated, in that its respective solenoid-controlled gas valve 98 would issue high pressure gas to the dual state valve 84 with high pressure gas to place it in one state and then not supply it with high pressure gas to place it in another state. In one possible embodiment, the dual setting valve 84 be a spring-biased pintle/shuttle piston valve with two channels, each channel connecting a respective set of ports on the outside of the valve body. The pintle or piston could be biased so that when the dual setting valve 84 is unpressurized, the piston/pintle blocks first channel and first set of port channel while allowing the second channel and second set to port free passage through the valve. When the high pressure gas is delivered by the respective solenoid-operated air valve to the dual state valve's high pressure inlet/outlet to pressurize the dual state valve, high air pressure could move the piston/pintle against its biasing spring to now unblock the first channel and its ports while blocking the second channel and its ports.

The solenoid-operated gas valves 96 (as selected by one skilled in that art) can be simple air valve that is operated by a electric-powered solenoid 100 to alternatively connect the respective dual state valve inlet/outlet to either a high pressure gas supply line or an outside atmospheric vent. The electric solenoid 100 could mechanically power the air valve. The electric solenoid 100 could be connected to the electronic control unit 30 and be assigned to its own timer circuit 108 to control when the electrical solenoid 100 operates (causing the air valve to connect the dual state valve to high pressure gas system or atmospheric vent, resulting in changing dual state valve's state.) The LN 566 timer circuits for the solenoid 100 could be set to operate for predetermined sets of time to cause the dual state valves 84 to deliver predetermined amounts of gas/fluid (e.g., to accommodate different holding capacities of different sized fluid containers.) The LN 566 timer circuits of the electronic control unit 30 could also be linked together to offer a predetermined order of operations for the dual state valves 84 (e.g., one valve first operates to blow gas through the fluid container to expel any fluid in the fluid container, another valve later operates to deliver a specific amount of fluid to refill the fluid container.)

In one embodiment, one cap system 24 could be serviced by two valve circuits 28 (one for supplying low pressure gas and the other for supplying desired pressurized fluid.) In an instance, each dual state valve 84 could have one port from a first port set connected with one port from the second port set, the two connected ports could then be connected to a respective manifold inlet/outlet 76, 77 (e.g., the pressurized fluid dual state valve 116 connects to the manifold's fluid inlet/outlet 76 while the low pressure gas dual state valve 118 connects to the manifold's low pressure gas inlet/outlet 77.) Of the dual state valve's remaining ports, one could be connected to a common drain/vent 110 while the other port is connected to the pressurized fluid/low pressure gas supply line (e.g., for fluid dual state valve 116, its remaining port is connected to the pressurized fluid supply line, for the low pressure gas dual state valve 118, its remaining port is connected to the low pressurize gas supply line.)

As described earlier, a manifold-mounted electrical pressure switch 80 (as selected by one skilled in the art) could be used to mechanically detect that an appropriate cap/fluid container combination is appropriately seated in and sealed to the respective manifold 38. The electrical pressure switch 80 as connected to the electronic control unit 30 could electronically isolate (e.g., prevent completion of solenoid's electronic circuit by the electronic control unit 30) the respective solenoids 100 from the electronic control unit 30 to prevent their operation (e.g., keeping the dual state valves 84 in inactive or vented status) if it did not detect the proper placement of the fluid container 12. This could prevent the filling station 20 from accidently operating without a fluid container 12 in place to prevent unwanted fluid spillage by the filling station 20.

In one embodiment, the timer circuits 108 for the two dual state valves 84 could be set to run in inverse (e.g., flip-flop) or in alternative states to one another (e.g., if the pressurized gas dual state valve 84 is set to deliver its supply to the manifold 38, then the other (e.g., low pressure gas) dual state valve 118 is set to vent.) For example, if the low pressure gas dual valve 118 is to deliver low pressure gas to the manifold, then the pressurized fluid dual state valve 116 is set to vent so that as the low pressure gas leaves the low pressure gas dual state valve 118 and enters the manifold 38 through the low pressure gas inlet/outlet 77 to be directed through the sealing plunger 52/low pressure apertures 54 to enter the fluid container 12. Once the low pressure gas begins to fill the fluid container's interior 14, it forces any fluid present into the fluid pickup tube 56 to leave the fluid container 12, pass through the cap 36, sealing plunger 52, remainder of the manifold 38 to exit the manifold's fluid inlet/outlet 76 to go to the pressurized fluid dual state valve 116. It then passes through the pressurized fluid dual state valve 116 to be delivered to the common drain/vent 110. As the procedure continues, the timer circuits 108 of the electronic control unit 30 cause both valve circuits 116, 118 to change their operating states. Now the pressurized fluid dual state valve 116 is set to deliver fluid to the manifold 38 while the low pressure gas dual state valve 118 is sent to vent. As the pressurized fluid is sent to the manifold's fluid inlet/outlet 76, it is directed though the manifold 38, sealing plunger 52, cap 36 and into the fluid container's interior 14 via the fluid pickup tube 56. As the fluid begins to fill the fluid container 12, the displaced air is moved out of the fluid container 12, through the low pressure apertures 54, the cap 36, and the sealing plunger 52 to leave the manifold 38 through the manifold's low pressure gas inlet/outlet 77 to be directed to the low pressure gas dual state valve 118. The displaced air is directed though the low pressure gas dual state valve 118 and on to common drain or vent 110. Once the timed/predetermined amount of fluid is delivered, the timing or timer circuit 108 for the pressurized fluid dual state valve 116 could deactivate its respective solenoid 100, turning off the respective air valve (set to vent) and cause the pressured fluid dual state valve 116 to be reset to vent.

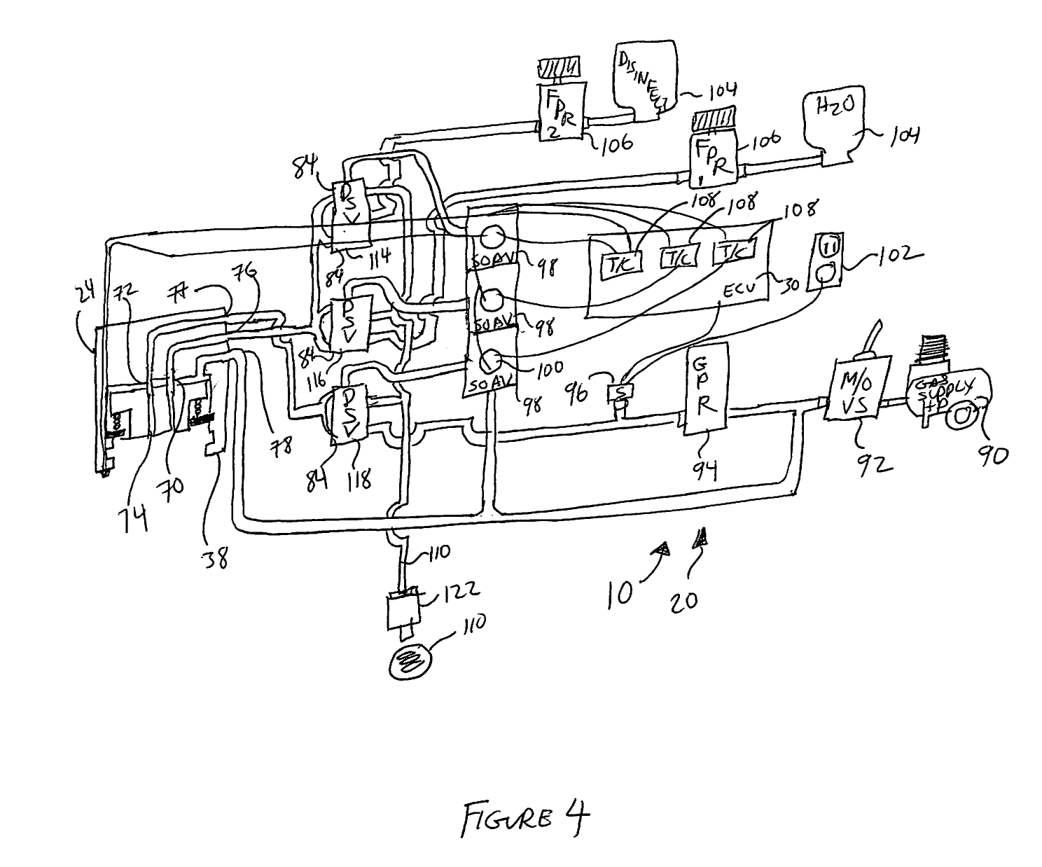

As substantially shown in FIG. 4, an example of the adaptability of the invention 100 to easily add similar valve circuits 28 to the filling station 20, an additional valve circuit 28 could be connected to respective timer circuit 108 added to the electronic controlled unit 30 for delivering disinfectant to clean the fluid container 12. In such an embodiment, the filling station 20 could have a pressurized (50 PSI) disinfectant supply to deliver the disinfectant to the disinfectant dual state valve 114. The disinfectant dual state valve 114 could have one port from each of its set of ports connected together and connect to the manifold's pressurized fluid inlet/outlet 76 (along with the other pressurized fluid sterile water dual state valve 116.) One other port could be connected to the pressurized fluid (disinfectant) line while the remaining port could be connected to the common drain/vent line 110.

It should be noted that the common drain/vent line 110 should be attached to a check valve or anti-siphon valve 122 to prevent backup in the common drain/vent 110 from contaminating pressurized supplies or other portions of the filler station 20 and the like.

One possible set of operation commands for this embodiment could be 1) purge the fluid container of fluid (operate gas valve, vent water and disinfectant valves); 2) add disinfectant to fluid container (operate disinfectant valve, vent gas and water valves); 3) add water to disinfectant (operate water valve, vent gas and disinfectant valves); 4) gas purge water/disinfectant from fluid container (operate gas valve, vent water and disinfectant valves); 5) fill fluid container with water flush (operate water valve, vent gas and disinfectant valves); 6) purge water flush from fluid container (operate gas valve, vent water and disinfectant valves); 7) refill fluid container with water (operate water valve, vent gas and disinfectant valves); shut off/vent high pressure system to turn off filling station to remove cleaned and filled water container from filling station for use with self-contained dental water supply system. The operational commands could be suitably altered to product a fluid container with water/disinfectant mixture for flushing out the self-contained dental water supply system.

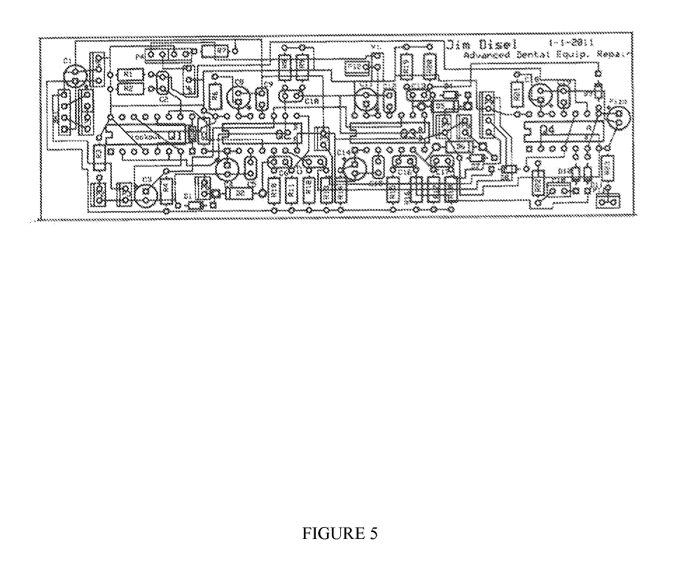

As substantially shown in FIG. 5, one possible electronic circuitry for the electronic control unit could be electronic circuitry wherein R1=10 K ohm resister, R2=10 K ohm resister, R3=240 ohm resister, R4=10 K ohm resister, R5=160 K ohm resister, R6=100 K ohm resister, R7=240 ohm resister, R8=10 K ohm resister, R9=10 K ohm resister, R10=10 K ohm resister, R11=10 K ohm resister, R12=10 K ohm resister, R13=10 K ohm resister, R14=210 K ohm resister, R15=10 K ohm resister, R16 K ohm resister =10 K ohm resister, R17=10 K ohm resister, R18=10 K ohm, R19=10 K ohm resister, R20=10 K ohm resister, R21=1K ohm resister, Q-1(and Q-2, Q-3, Q-4)=LN 556 timer IC, C-1=capacitor 220UF/35V-eletrolytic, C-2=capacitor DISC 103, C-3=capacitor 1UF/35V, C-4=capacitor 220UF/35V, C-5=capacitor DISC 103, C-6=capacitor DISC 103, C-7=capacitor DISC 103, C-8=capacitor 220UF/35V, C-9=capacitor DISC 103, C-10=capacitor DISC 103, C-11=capacitor 220UF/35V, C-12=capacitor DISC 103, C-14=capacitor 220UF/35V, C-15=capacitor DISC 103, C-16=capacitor DISC 103, C-17=capacitor DISC 103, C-18=capacitor 220UF/35V, C-19=capacitor DISC 103, D1=diode 1N4108, D2, D6 =diode 1N4001; D3, D4, D5, D7, D8, D9, D10, D11=diode 1N4118, pizo=3-16 VDC pizo.

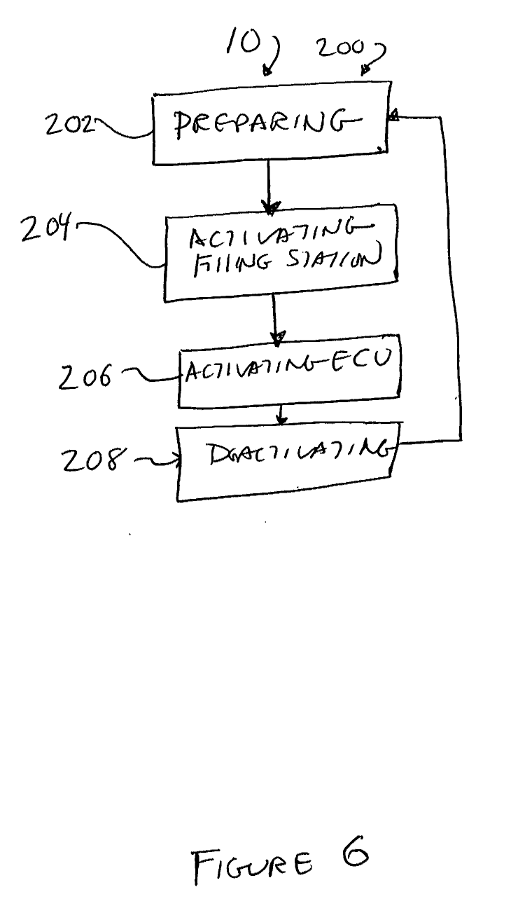

As substantially shown in FIG. 6, one possible embodiment of the invention 10 could be a process or methodology 200 for operating the filling station staring with step 202, preparing the fluid container. In this step, the size and shape of the fluid container is selected along with the appropriate length pickup tube. The pickup tube is attached to the cap and the cap attached to the open end of the fluid container so that the pickup is locked within the interior of the fluid container and the container is generally sealed.

The above procedure could be skipped if a used previously prepared fluid container (e.g., containing some fluid) is to be used. The fluid container could then be seated within the manifold for processing by the filling station. The electrical pressure switch could detect the presence of cap or fluid container and close the circuit between the electronic circuit board and solenoids for the circuit valves continuously connected to the manifold. As this step is substantially completed, the process 200 could then proceed to step 204, activation of the filling station.

In step 204, activating the filling station, the gas and fluid source could be activated (e.g., turning on the air compressor/tank). The manually-operated air valve can then be used to continuously connect the high pressure gas system to the manifold and the air pressure regular. The high pressure gas system to the manifold could cause the sealing plunger to seat upon the cap; secure the cap/fluid container to the manifold; and continuously connect the fluid container interior to the manifold. The high pressure gas could also be directed to the air valve portions of the solenoid-operated air valves of the valve circuits for actuation of the dual state valves. The air pressure regulator could convert the incoming high pressure gas (e.g., 80 PSI) to low pressure gas of a predetermined pressure (e.g., 50 PSI) and direct the low pressure gas to the gas pressure electrical switch. In the presence of the low pressure gas, the gas pressure electrical switch could close the circuit between the electrical power supply and the electronic control unit to energize the electronic control unit. The low pressure gas could be directed from the gas pressure electrical switch to the valve circuit that will deliver the low pressure gas to the manifold.

The fluid source (e.g., sterile water supply) could proceed through the fluid pressure regulator to generate the pressurized fluid system operating at a predetermined pressure (e.g., 50 PSI). The pressurized fluid system could then proceed to the valve circuit that will deliver the pressurized fluid to the manifold. As this step is substantially completed the process 200 could proceed to step 206, activation of the electronic controller.

At step 206, activating of the electronic controller, the dental operator could select for the fluid container size (large or small) by selecting by stitch different sets of capacitors and resistors to the timer circuits to set different time durations of operations to control the amount of fluid or gas to be placed into the fluid container. The on button could be pressed to start the process. The low pressure gas valve circuit could be activated (with the pressurized fluid circuit being set to vent) to deliver low pressure air to the manifold, through sealing plunger, the low pressure apertures and into the fluid container. The low pressure gas in the fluid container could force the evacuation of any fluid present in the fluid container. The fluid could exit the fluid container through the fluid pickup tube, through the sealing plunger, out the manifold to be vented by the pressurized fluid valve circuit to the common drain/vent. Once the controlling timer circuit came to end of the time period for its operation, it could shut down the low pressure gas valve circuit (set to vent state) and then send to activate the signal to timer circuit for the pressurized fluid system valve circuit.

The pressurized fluid system timer circuit could activate the circuit and change it state from vent to manifold delivery of pressurized fluid. The pressurized fluid could enter the manifold be directed through the sealing plunger to the fluid pickup tube to appropriately fill the fluid container. The air in the fluid container that is displaced by the fluid could travel out the low pressure air apertures, through the sealing plunger, out of the manifold to the low pressure gas valve circuit and be directed to the common drain/vent. Once the pressurized fluid system timer circuit has run its course, it could deactivate the pressurized fluid system valve circuit to a vent state and then send a notification visa an indicator to the dental operative that the filling process is completed. As this step is substantially completed, the process 200 could proceed to step 208, deactivation.

In step 208, deactivating, the dental operator, upon noticing the activation of the indicator, could turn the manually-operated air valve to off/vent to disconnect high pressure gas system from then rest of the filling station. This act could vent the high pressure gas from the rest of the filling station causing the sealing plunger to recede away form the cap to allow the cap/fluid container combination to be removed from the manifold/filling station. Once the cap/fluid container is removed, the manifold pressure electrical switch could deactivate the respective solenoids from the electronic control unit. The low pressure gas could vent through the gas pressure regulator and out the manually-operated air valve the causing the gas pressure electrical switch to de-energize the electronic control unit. If the dental operator wishes to refill another cap/fluid container combination, the process could proceed back to step 202.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A filling station for fluid containers used in self-contained dental water supply systems comprising:
(A) at least one pressurized fluid system;
(B) at least one low pressure gas system;
(C) a first valve circuit continuously connecting to the at least one pressurized fluid system;
(D) a second valve circuit continuously connecting to the at least one low pressurized gas system;
(E) a manifold continuously connecting to the first and the second valve circuits;
(F) a cap that attaches to a fluid container used in self-contained dental water supply system, the cap reversibly and continuously connects an interior of the fluid container to the manifold;
(G) an electronic control unit that utilizes one or more timer circuits, each timer circuit connects to its respective valve circuit to control that valve circuit's operations;
wherein each timer circuit operates its respective valve circuit for a predetermined amount of time to deliver a predetermined amount of gas or fluid at predetermined pressure into the interior of the fluid container.

2. The filling station of claim 1 wherein the valve circuit is further comprised of solenoid-controlled air valve, the solenoid being electronically connected to and controlled by its respective timer circuit, the air valve being continuously connects a high pressure gas system to a dual state valve to cause the dual state valve to go from one state to another state.

3. The filling station of claim 2 wherein the dual state valve is further continuously connected to either the at least one low pressure gas system or to the at least one pressurized fluid system.

4. The filling station of claim 2 wherein the dual state valve is continuously connected to a common drain/vent.

5. A filling station of claim 1 wherein the valve circuit is comprised of a solenoid-operated dual state valve, a solenoid of the solenoid-operated dual state valve being connected to its respective timer circuit of the electronic control unit and the dual state valve continuously connects to the manifold to deliver either a pressurized fluid or a low pressure gas to the manifold, the dual state further continuously connects to a common drain/vent.

6. The filling station of claim 1 wherein the first valve circuit operates to deliver pressurized fluid to the interior of the fluid container while the second valve circuit continuously connects the interior of the fluid container to a common drain/vent.

7. The filling station of claim 1 wherein the second valve circuit operates to deliver pressurized gas to the interior of the fluid container while the first valve circuit continuously connects the interior of the fluid container to a common drain/vent.

8. The filling station of claim 1 further comprising of a high pressure gas system that is continuously connected by a manually-operated air valve to the manifold to move a sealing plunger within an open-ended cavity of the manifold to seat a sealing plunger upon the cap to continuously connect the interior of the fluid container to the manifold.

9. The filling station of claim 8 wherein the disconnection by the manually-operated air valve of the high pressure gas system from the manifold causes the sealing plunger to be recessed within the open-ended cavity to allow the fluid container to be removed from the manifold.

10. A filler station for fluid containers used in self-contained dental water supply systems comprising:
(A) a plurality of valve circuits, each valve circuit comprising of a dual state valve, each dual state valve continuously connecting to a manifold, each dual state valve is controlled by a respective solenoid-operated air valve, the solenoid-operated air valve continuously connecting the dual state valve to a high pressure gas system to actuate the dual state valve from one state of operation to another state of operation;
(B) at least one pressurized fluid system pressurized to a predetermined level, the least one pressurized fluid system continuously connects to a first valve circuit;
(C) at least one low pressure gas system pressurized to a predetermined level, the at least one low pressure gas system continuously connects to a second valve circuit;
(D) a manifold that continuously connects to a fluid container;
(E) an electronic controller unit that has more than one timer circuit, each timer circuit being connected to its respective solenoid of the solenoid-controlled air valve, each timer circuit running its respective valve circuit for a predetermined amount of time to deliver a predetermined amount of pressurized fluid or low pressure gas to the fluid container.

11. The filing station of claim 10 wherein the first and second valve circuits are continuously connected to a common drain/vent.

12. The filing station of claim 11 wherein the first valve circuit delivers pressurized fluid into the interior of the fluid container while the second valve circuit vents the interior of the fluid container to the common drain/vent.

13. The filing station of claim 11 wherein the second valve circuit delivers low pressure gas into the interior of the fluid container while the first valve circuit vents the interior of the fluid container to the common drain/vent.

14. The filing station of claim 11 further comprising of a high pressure gas system that continuously connects to the manifold to move a sealing plunger within an open-ended cavity of the manifold to seat the sealing plunger upon a cap connected to the fluid container to continuously connect an interior of the fluid container to manifold.

15. The filing station of claim 14 wherein the high pressure gas system connects to a manually-operated air valve switch that in one state disconnects the high pressure system to the rest of the filling station and in another state connects the high pressure system to the rest of the filling station, act of disconnecting the high pressure system allows a sealing plunger of the manifold to recede within an open-ended cavity of the manifold.

16. The filing station of claim 15 wherein the state of connection energizes the electronic controller unit wherein the state of disconnection de-energizes the electronic controller unit.

17. The filing station of claim 11 further comprising a second pressurized fluid system delivering a pressurized fluid different from the pressurized fluid carried by the at least one pressurized fluid system, the second pressurized fluid system continuously connects to the third valve circuit, the third valve circuit connects to its respective timer circuit, the third valve circuit continuously connects to a manifold inlet/outlet to which the first valve circuits is continuously connected.

18. The process for operation of a filing station for fluid containers used in a self-contained dental water supply system comprising of the following steps, but not necessarily in the order presented;
(A) providing a filing station with a manifold that continuously connects an interior of a fluid container to at least two or more valve circuits; one valve circuit continuously connects to the manifold to a pressurized fluid system or a common drain/vent, the pressurized fluid system being pressurized at a predetermined pressure, a second valve circuit continuously connects the manifold to a low pressurize gas system or the common drain/vent, the low pressure gas system being pressurized at the predetermined pressure, the valve circuits being connected to and operated by respective timer circuits of an electronic controller unit;
(B) activating either the first or second valve circuits through its respective timer unit for a predetermined amount time to deliver either a gas or a fluid in a predetermined amount to the interior of the fluid container; and
(C) de-activating the remaining valve circuit through its respective timer unit to continuously connect the interior of the fluid container to a common drain/vent, the activating and deactivating occurring at the same time.

19. The process for operation a filing station of claim 18 further comprising of a step of providing a high pressure gas system that is connected to the valve circuits.

20. The process for operation a filing station of claim 19 wherein activating the first or second valve circuit further comprises of the step activating a solenoid by a timer circuit to continuously connect the high pressure system to a dual stage valve to change the dual state valve from one state to another state.
